(19) United States
(12) Patent Application Publication
(10) Pub. No.: US 2026/0291660 A1
(43) Pub. Date: Sep. 24, 2026

(54) METHODS, HALF-DUPLEX COMMUNICATIONS DEVICES AND INFRASTRUCTURE EQUIPMENT

(71) Applicant: Sony Group Corporation, Tokyo (JP)

(72) Inventor: Shin Horng WONG, Basingstoke (GB)

(73) Assignee: Sony Group Corporation, Tokyo (JP)

(21) Appl. No.: 19/473,509

(22) PCT Filed: Mar. 28, 2024
(86) PCT No.: PCT/EP2024/058604

§ 371 Date: Oct. 8, 2025

(30) Foreign Application Priority Data
May 10, 2023 (EP) 23172617.5

(51) Int. Cl. H04L 5/00

(52) U.S. Cl. CPC H04L 5/0007; H04L 5/0044; H04L 5/0055

(57) ABSTRACT

A method of operating a communications device includes sending an uplink transmission via a wireless access interface having OFDM slots. At least one slot includes Subband Full Duplex (SBFD) OFDM symbols, each with multiple downlink resource units (RUs) and multiple uplink RUs. Infrastructure equipment transmits a synchronization signal block (SSB) in downlink RUs of one or more SBFD symbols. The device determines that a subset of uplink RUs within the SBFD symbol(s) used for the SSB are disabled for uplink, and transmits at least part of the uplink in other uplink RUs of the same SBFD symbol(s).

### BACKGROUND

### Field of Disclosure

The present disclosure relates to half-duplex communications devices, infrastructure equipment, and methods of operating half-duplex communications devices and infrastructure equipment in a wireless communications network.

The present application claims the Paris convention priority of European patent application number EP23172617.5, the contents of which are hereby incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Example embodiments can provide a method of operating a half-duplex, HD, communications device. The method comprises transmitting an uplink transmission to infrastructure equipment of a wireless communications network via a wireless access interface. The wireless access interface comprises one or more Orthogonal Frequency Division Multiplexing, OFDM, slots. One or more of the OFDM slots comprises one or more Subband Full Duplex, SBFD, OFDM symbols. Each of the one or more SBFD OFDM symbols comprises a plurality of downlink resource units and a plurality of uplink resource units. One or more of the SBFD OFDM symbols are used by the infrastructure equipment for transmitting a synchronisation signal block, SSB. The SSB is transmitted by the infrastructure equipment in a plurality of the downlink resource units in the one or more SBFD symbols used for transmitting the SSB The transmitting of the uplink transmission comprises determining that a subset of the uplink resource units in the one or more SBFD OFDM symbols used by the infrastructure equipment for transmitting the SSB are disabled for uplink transmissions, and transmitting at least a part of the uplink transmission in a plurality of the other uplink resource units in the one or more SBFD OFDM symbols used by the infrastructure equipment for transmitting the SSB.

Since only a subset of the uplink resource units in the one or more SBFD OFDM symbols used by the infrastructure equipment for transmitting the SSB are disabled for uplink transmissions, the other uplink resource units in the one or more SBFD OFDM symbols used by the infrastructure equipment for transmitting the SSB are available for uplink transmission. Uplink transmissions can therefore be transmitted in these other uplink resource units without interruption. As will be appreciated from an understanding of the forthcoming description, this can reduce inter-subband CLI to other communication devices that may be receiving the SSB and reduce communications resource wastage.

Example embodiments also provide another method of operating a half-duplex, HD, communications device. The method comprises transmitting an uplink transmission to infrastructure equipment of a wireless communications network via a wireless access interface. The wireless access interface comprises one or more OFDM, slots. One or more of the OFDM slots comprises a plurality SBFD OFDM symbols. Each of the one or more SBFD OFDM symbols comprises a plurality of downlink resource units and a plurality of uplink resource units. One or more of the SBFD OFDM symbols are used by the infrastructure equipment for transmitting an SSB. The SSB is transmitted by the infrastructure equipment in a plurality of the downlink resource units in the one or more SBFD OFDM symbols used for transmitting the SSB. The transmitting of the uplink transmission comprises determining, based on a type of the uplink transmission, to transmit at least a part of the uplink transmission in a plurality of the uplink resource units in the one or more SBFD OFDM symbols used by the infrastructure equipment for transmitting the SSB.

By determining whether to transmit at least a part of the uplink transmission in a plurality of the uplink resource units in the one or more SBFD OFDM symbols used by the infrastructure equipment for transmitting the SSB based on the type of the uplink transmission, the uplink transmission can be prioritised over the SSB when required. For example, although the transmission of the uplink transmission may cause inter-subband CLI to other communications devices which may be receiving the SSB, such embodiments recognise that it may be acceptable to have such interference due to the importance of the uplink transmission.

Embodiments of the present technique can also provide half-duplex communications devices, infrastructure equipment, circuitry for half-duplex communications devices, circuitry for infrastructure equipment computer programs, and computer-readable storage mediums.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically illustrates an example of a cell common slot format configuration;

FIG. 5 schematically represents an example of non-overlapping subbands for uplink and downlink transmissions;

FIG. 6 schematically represents an example of non-overlapping subbands for uplink and downlink transmissions;

FIG. 7 schematically illustrates an example of intra-cell cross link interference;

FIG. 8 schematically illustrates an example of inter sub-band interference;

FIG. 9 schematically illustrates the components of an SSB;

FIG. 10 schematically illustrates an SSB burst set transmitted on SSB beams;

FIG. 11 schematically illustrates an SSB in SBFD OFDM symbols;

FIG. 12 schematically illustrates uplink resource units which are disabled for uplink transmissions;

FIG. 13 is a flow diagram illustrating a method of operating a communications device in accordance with example embodiments;

FIG. 14 schematically illustrates a subset of uplink resource units which are disabled for uplink transmissions in accordance with example embodiments;

FIG. 15 schematically illustrates a Frequency Separation FssB to determine disabled uplink resource units in accordance with example embodiments.

### DETAILED DESCRIPTION OF THE EMBODIMENTS

### Long Term Evolution Advanced Radio Access Technology (4G)

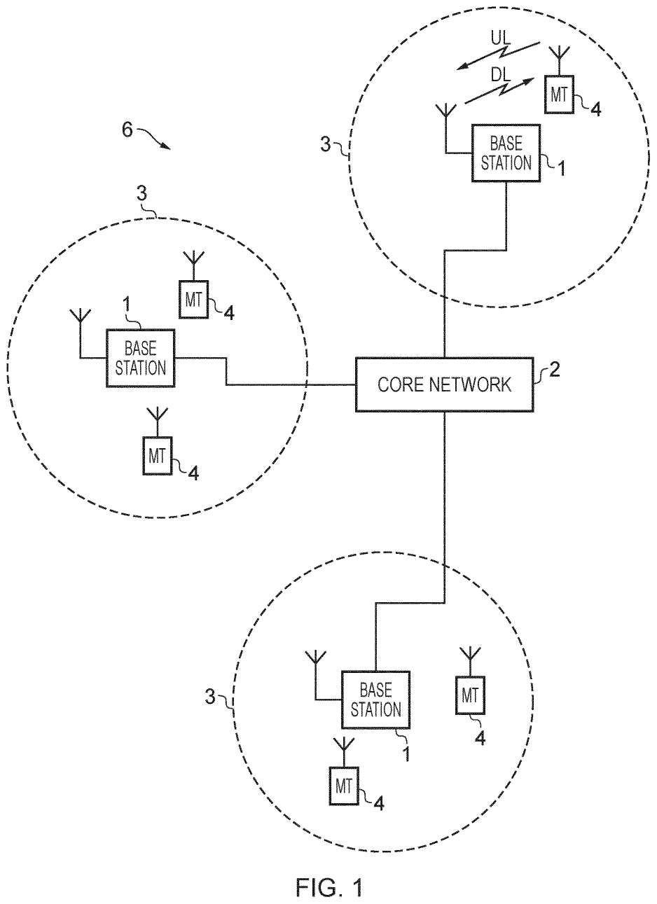

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example embodiments is not intended to indicate these embodiments are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999 %) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

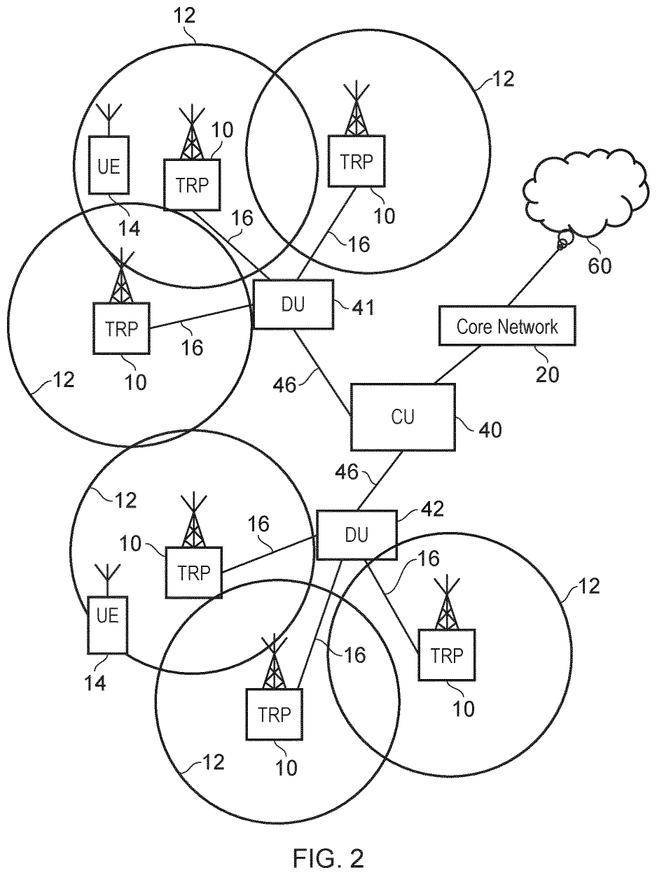

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 60.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given embodiment is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the embodiment at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

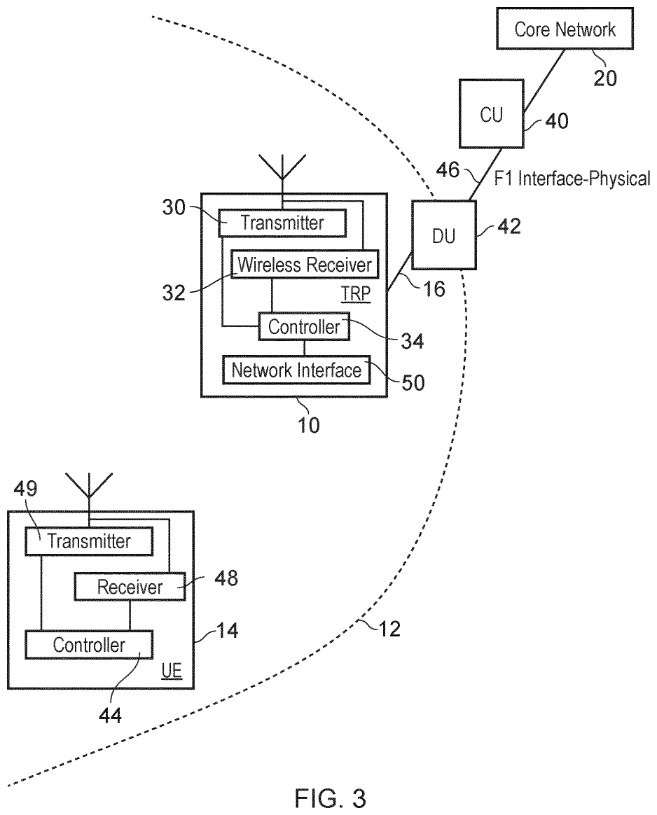

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Full Duplex Time Division Duplex (FD-TDD)

NR/5G networks can operate using Time Division Duplex (TDD), where an entire frequency band or carrier is switched to either downlink or uplink transmissions for a time period and can be switched to the other of downlink or uplink transmissions at a later time period. Currently, TDD operates in Half Duplex mode (HD-TDD) where the gNB or UE can, at a given time, either transmit or receive packets, but not both at the same time. As wireless networks transition from NR to 5G-Advanced networks, a proposed new feature of such networks is to enhance duplexing operation for Time Division Duplex (TDD) by enabling Full Duplex operation in TDD (FD-TDD) [3], [4].

In FD-TDD, a gNB can transmit and receive data to and from the UEs at the same time on the same frequency band. In addition, a UE can operate either in HD-TDD or FD-TDD mode, depending on its capability. For example, when UEs are only capable of supporting HD-TDD, FD-TDD is achieved at the gNB by scheduling a DL transmission to a first UE and scheduling a UL transmission from a second UE within the same orthogonal frequency division multiplexing (OFDM) symbol (i.e. at the same time). Conversely, when UEs are capable of supporting FD-TDD, FD-TDD is achieved both at the gNB and the UE, where the gNB can simultaneously schedule this UE with DL and UL transmissions within the same OFDM symbol by scheduling the DL and UL transmissions at different frequencies (e.g. physical resource blocks (PRBs)) of the system bandwidth. A UE supporting FD-TDD requires more complex hardware than a UE that only supports HD-TDD. Development of current 5G networks is focused primarily on enabling FD-TDD at the gNB with UEs operating in HD-TDD mode.

Motivations for enhancing duplexing operation for TDD include an improvement in system capacity, reduced latency, and improved uplink coverage. For example, in current HD-TDD systems, OFDM symbols are allocated only for either a DL or UL direction in a semi-static manner. Hence, if one direction experiences less or no data, the spare resources cannot be used in the other direction, or are, at best, under-utilized. However, if resources can be used for DL data and UL data (as in FD-TDD) at the same time, the resource utilization in the system can be improved. Furthermore, in current HD-TDD systems, a UE can receive DL data, but cannot transmit UL data at the same time, which causes delays. If a gNB or UE is allowed to transmit and receive data at the same time (as with FD-TDD), the traffic latency will be improved. In addition, UEs are usually coverage limited in their UL transmissions when located close to the edge of a cell. While the UE coverage at the cell-edge can be improved if more time domain resources are assigned to UL transmissions (e.g. repetitions), if the UL direction is assigned more time resources, fewer time resources can be assigned to the DL direction, which can lead to system imbalance. Enabling FD-TDD would allow a UE to be assigned more UL time resources when required, without sacrificing DL time resources.

### Slot Format Configuration

A Slot Format in a TDD system describes a link direction of each OFDM symbol. An OFDM symbol may be configured as Downlink (DL), Uplink (UL) or Flexible (FL). The Slot Format may be configured semi-statically via RRC signaling and/or dynamically via DCI indication. In a semi-static Slot Format configuration, the link direction of the OFDM symbols can be configured using cell common signaling in system information blocks (SIBs) or using UE dedicated RRC signaling. In a dynamic Slot Format configuration, the link direction of the OFDM symbols can be indicated using a Group Common DCI (GC-DCI) and/or DL/UL Scheduling Grant.

A cell common slot format may be configured in RRC parameter TDD-UL-DL-Pattern. A cell common slot format may comprise one or more patterns. For example, a cell common slot format may comprise two patterns including Pattern 1 and Pattern 2 where each of Pattern 1 and 2 have a period that can be configured with values={0.5, 0.625, 1, 1.25, 2, 2.5, 5, 10} ms. Pattern 1 and Pattern 2 may be concatenated and repeated periodically. In some cases, Pattern 2 is optional. Patterns 1 and 2 may be defined by one or more of:
The number of slots from the start of the pattern that are DL, i.e., d_{slot,1} and d_{slot,2} for Pattern 1 and Pattern 2 respectively.
The number of OFDM symbols d_{symbol,1} and d_{symbol,2} after the end of d_{slot,1} and d_{slot,2} slots for Pattern 1 & Pattern 2 respectively that are DL OFDM symbols.
The number of slots from the end of the pattern that are UL, i.e., u_{slot,1} and u_{slot,2} for Pattern 1 and Pattern 2 respectively.
The number of OFDM symbols u_{symbol,1} and u_{symbol,2} before the start of u_{slot,1} and u_{slot,2} for Pattern 1 and Pattern 2 respectively that are UL OFDM symbols.
The OFDM symbols between the end of d_{symbol,1} and the start of u_{symbol,1} are Flexible OFDM symbols in Pattern 1. Similarly, the OFDM symbols between the end of d_{symbol,2} and the start of u_{symbol,2} are Flexible OFDM symbols in Pattern 2.

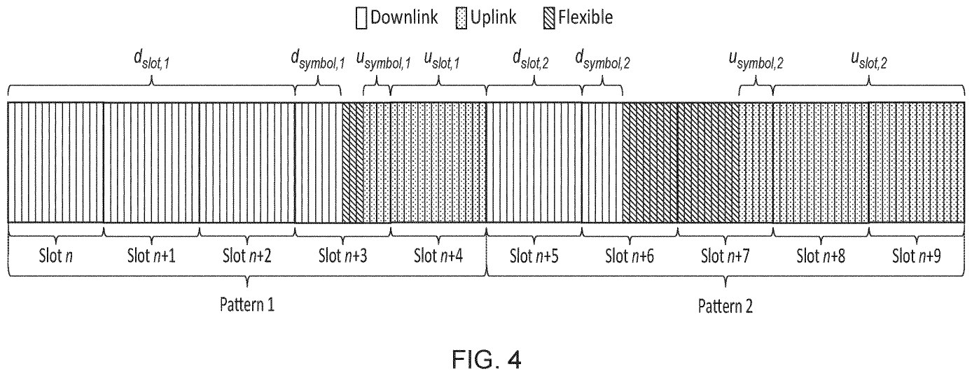

An example of a cell common slot format for a 15 kHz Subcarrier Spacing operation is shown in FIG. 4. Pattern 1 has a period of 5 ms with d_{slot,1}=3, d_{symbol,1}=7, u_{slot,1}=1 and u_{symbol,1}=4. Pattern 2 has a period of 5 ms with d_{slot,2}=1, d_{symbol,2}=6, u_{slot,2}=2 and u_{symbol,2}=5. The periodicity of the overall TDD pattern is the sum of the period of Pattern 1 and Pattern 2. In this example, the periodicity of the overall TDD pattern is 10 ms.

The Slot Format may be further semi-statically configured using UE dedicated RRC signaling. For example, Flexible OFDM symbols configured using the cell common Slot Format configuration can be semi-statically configured as DL, UL or remain as Flexible.

The OFDM symbols that are semi-statically configured as Flexible after cell common and UE dedicated configurations may be indicated dynamically as DL, UL or remain as Flexible by a Dynamic Slot Format Indicator (SFI), which is transmitted in a Group Common (GC) DCI using DCI Format 2_0, where the CRC of the GC-DCI is masked with SFI-RNTI.

Flexible OFDM Symbols that remain Flexible after instruction from the SFI can be changed to a DL symbol or a UL symbol by a DL Grant or UL Grant respectively. In other words, a DL Grant scheduling a PDSCH that overlaps Flexible OFDM Symbols may convert these Flexible OFDM Symbols to DL symbols. Similarly, a UL Grant scheduling a PUSCH that overlaps Flexible OFDM Symbols may convert these Flexible OFDM Symbols to UL symbols.

### Subband Full Duplex (SBFD)

In SBFD, the frequency resource of a TDD system bandwidth or Bandwidth Part (BWP) (i.e. at the UE/gNB) is divided into two or more non-overlapping sub-bands, where each sub-band can be DL or UL [5]. Guard subbands may be used between DL and UL subbands to reduce inter subband interference.

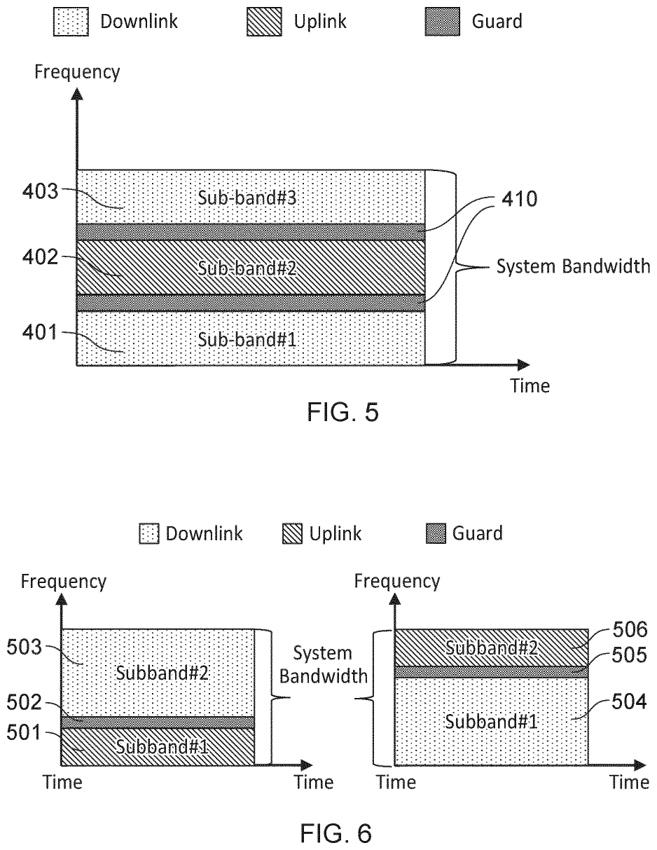

An example is shown in FIG. 5, where simultaneous DL and UL transmissions occur in different non-overlapping sub-bands 401 to 403, i.e. in different sets of frequency Resource Blocks (RB): Sub-band #1 401, Sub-band #2 402, Sub-band #3 403, such that Sub-band #1 401 and Sub-band #3 403 are used for DL transmissions whilst Sub-band #2 402 is used for UL transmissions.

While FIG. 5 shows the system bandwidth as being divided into three sub-bands, any number of sub-bands could be used. For example, the system bandwidth may be divided into four sub-bands, which may include the two downlink sub-bands 401, 403, the uplink sub-band 402 and another uplink subband, though other sub-band arrangements are envisioned. To reduce leakage from one sub-band 401 to 403 to another, a guard sub-band 410 may be configured between UL and DL sub-bands 401 to 403. Guard sub-bands 410 are configured between DL Sub-band #3 403 and UL Sub-band #2 402 and between UL Sub-band #2 402 and DL Sub-band #1 401.

The arrangement of sub-bands 401 to 403 shown in FIG. 5 is just one possible arrangement of the sub-bands and other arrangements are possible, and guard bands may be used in substantially any sub-band arrangement.

FIG. 6 shows two further examples with a DL and UL subband separated by a guard subband. For example, on the left-side of FIG. 6, a UL subband #1 501 is separated from a DL subband #2 503 by a guard subband 502. In this case, the DL subband #2 503 occupies a higher frequency portion of the system bandwidth than the UL subband #1 501. On the right-side of FIG. 6, a DL subband #1 504 is separated from a UL subband #2 506 by a guard subband 505. In this case, the UL subband #2 506 occupies a higher frequency portion of the system bandwidth than the DL subband #1 504.

### Intra-Cell Cross Link Interference (CLI) and Sub-Band Full Duplex (SBFD)

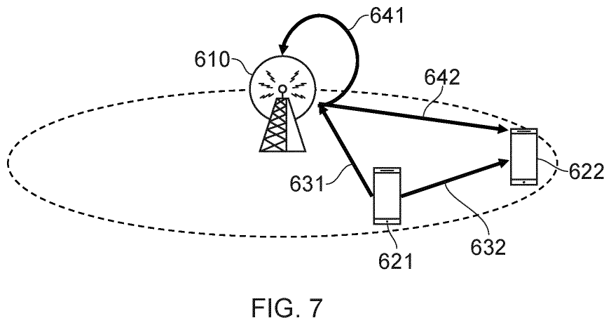

In addition to inter-cell CLI, FD-TDD also suffers from intra-cell CLI at the gNB and at the UE. An example is shown in FIG. 7, where a gNB 610 is capable of FD-TDD and is simultaneously receiving UL transmission 631 from UE1 621 and transmitting a DL transmission 642 to UE2 622. At the gNB 610, intra-cell CLI is caused by the DL transmission 642 at the gNB's transmitter self-interfering 641 with its own receiver that is trying to decode UL signals 631. At UE2 622, intra-cell CLI 632 is caused by an aggressor UE, e.g. UE1 621, transmitting in the UL 631, whilst a victim UE, e.g. UE2 622, is receiving a DL signal 642.

The intra-cell CLI at the gNB due to self-interference can be significant, as the DL transmission can in some cases be over 100 dB more powerful than the UL reception. Accordingly, complex RF hardware and interference cancellation are required to isolate this self-interference.

### Inter Sub-Band Interference

However, SBFD may suffer from inter sub-band interferences, which are caused by transmission leakage and receiver's selectivity. Although a transmission is typically scheduled within a specific frequency subband, i.e. a specific set of RBs, transmission power can leak out to other subbands. This occurs because subband filters are not perfect, and as such the roll-off of the filter will cause power to leak into subband adjacent to the intended specific frequency subband.

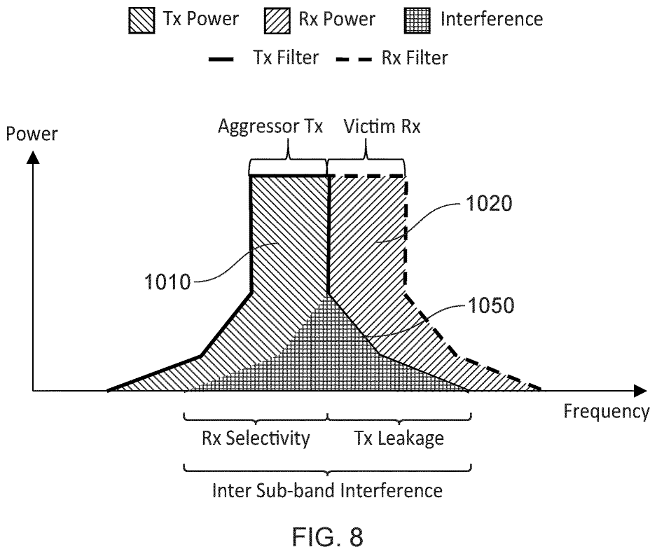

An example is shown in FIG. 8, where an aggressor transmits a signal in an adjacent subband 1010 at a lower frequency than the victim's receiving subband 1020. Due to roll-off of the transmission filter and nonlinearities in components of the transmitter, some transmission power is leaked into the victim's receiving subband 1020. Similarly, the receiver's filter is also not perfect and will receive unwanted power from the subband 1010. Therefore, the receiver will experience interference 1050.

### Synchronisation Signal Block (SSB)

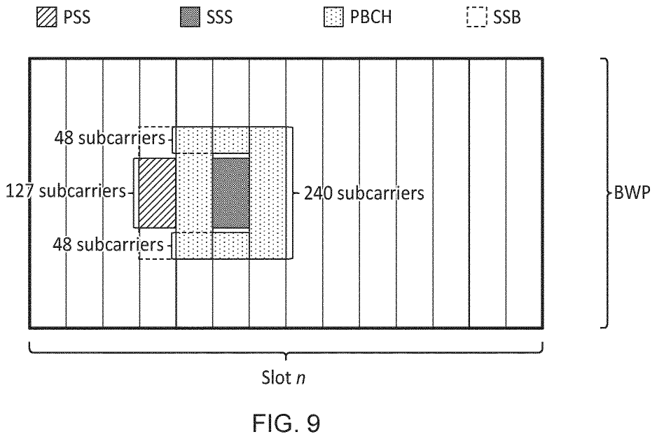

As will be known to one skilled in the art, the Synchronisation Signal Block (SSB) is used for initial access and cell reselection. An example of an SSB is schematically illustrated in FIG. 9.

As shown in FIG. 9, the SSB comprises of a Primary Synchronisation Signal (PSS), a Secondary Synchronisation Signal (SSS) and a Physical Broadcast Channel (PBCH). The SSB comprises information for a communications device, such as a UE, to detect, measure and access a cell. The SSB shown in FIG. 9 comprises 4 OFDM symbols and 240 subcarriers. The PSS and SSS each occupy 127 subcarriers. The PBCH occupies two OFDM symbols of 240 subcarriers and also 2 blocks of 48 subcarriers at the top and bottom of the SSS. The SSB may be configured with a periodicity, PssB, of between 5 ms and 160 ms.

An SSB burst set comprises a set of one or more time-multiplexed SSBs. Each SSB is transmitted in a burst set using a different beam, thereby enabling beam sweeping to be implemented for SSB. An SSB burst set may be confined within 5 ms and may comprise up to 4, 8 and 64 SSBs for frequency bands below 3 GHz, between 3 GHz-6 GHz and for FR2 respectively. As will be understood by one skilled in the art, SSB burst sets may be periodically transmitted.

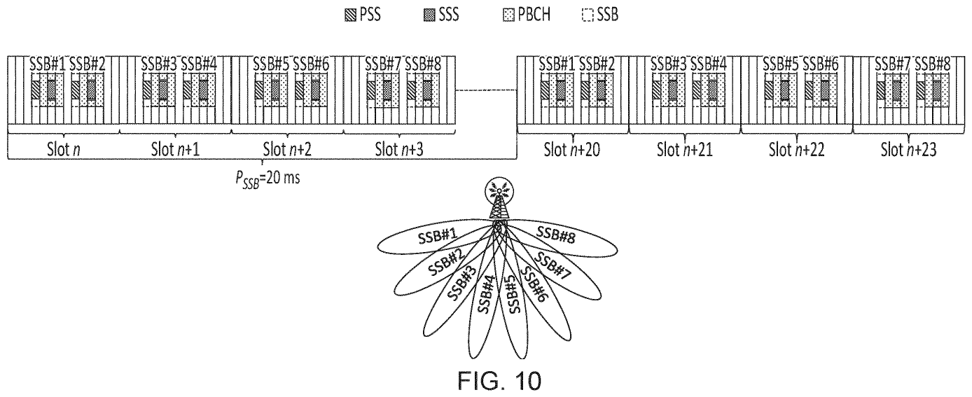

An example SSB burst set is shown in FIG. 10. The SSB burst set shown in FIG. 10 comprises 8 SSBs labelled as SSB #1, SSB #2, SSB #3, SSB #4, SSB #5, SSB #6, SSB #7 and SSB #8 respectively. Each of the SSBs in the burst set is transmitted using a different beam. In this example, 2 SSBs are configured per slot within 4 slots. Furthermore, the burst set is transmitted with a periodicity, PssB, of 20 ms. Although not shown in FIG. 10, the SSB burst set is transmitted by infrastructure equipment of a wireless communications network (such as a gNB) and received by a communications device (such as a UE).

The UE measures a signal quality of each SSB in the SSB burst set. The UE may then select one of the beams for data transmission or reception with the infrastructure equipment based on the measured signal quality. For example, the UE may select the beam on which the SSB with the highest measured signal quality was received. In initial access, the UE transmits its RACH using the selected beam. In one example, the measured signal quality of an SSB is an RSRP of the SSB. The UE may measure the RSRP of each SSB in the SSB burst set and select the beam on which the SSB with the highest RSRP was transmitted. Then, the UE transmits its RACH using the selected beam. In other examples, the UE does not select one of the beams for data transmission or reception following the measurement of the signal quality of each SSB in the SSB burst set. For example, the UE may transmit an indication of the measured quality of each SSB in the SSB burst set to the gNB. In this case, the gNB may select a beam for data transmission or reception with the UE based on the received indication. It will be appreciated that signal quality measurements of SSBs can be used for other purposes as will be known to one skilled in the art. In other words, the measurements of the signal quality of the SSBs may be used in for any process which relies on SSB signal quality measurement.

The measurement of the RSRP of an SSB may be referred to as “SS-RSRP”. The measurement of the RSRP of an SSB may comprise measuring the RSRP on resource elements where SSS is transmitted. Alternatively, or in addition, the measurement of the RSRP of an SSB may comprise measuring the RSRP on resource elements where PBCH DMRS is transmitted.

The measured signal quality of an SSB may be a Reference Signal Received Quality (SS-RSRQ) of the SSB. The SS-RSRQ is defined as the ratio of N×SS-RSRP/RSSI (Received Signal Strength Indicator), where N is the number of resource blocks. For example, the RSSI in NR is measured in one or more OFDM symbols in a SS/PBCH Block Measurement Time Configuration (SMTC). The SMTC is a configuration to the UE to set time window for measurement by using SSB. The OFDM symbols used for RSSI measurement can be configured by higher layers.

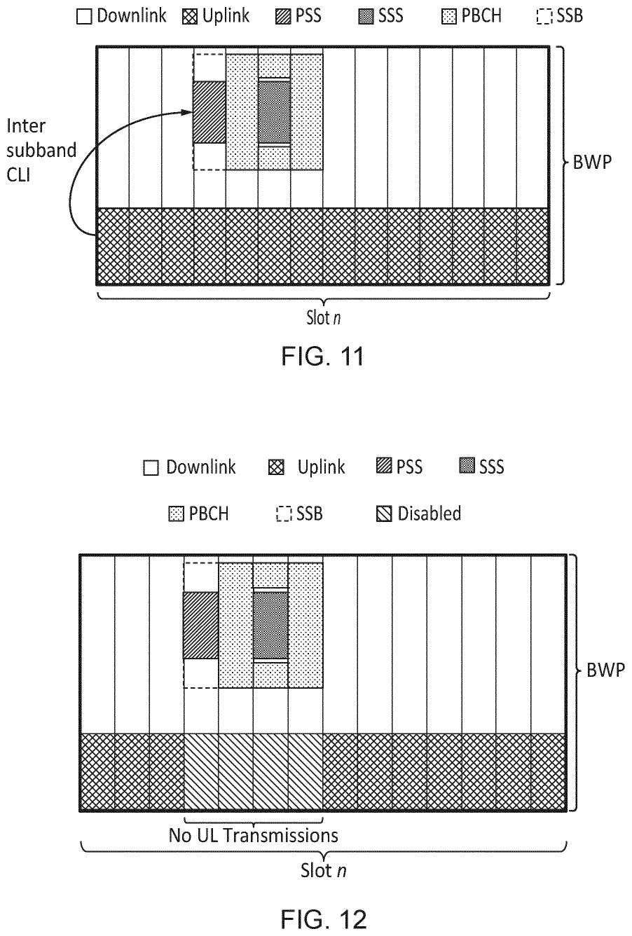

The transmission of SSB in OFDM symbols configured as SBFD (i.e. SBFD OFDM symbols) is being considered in 3GPP. An example of the transmission of an SSB in OFDM symbols is shown in FIG. 11. In FIG. 11, slot n comprises a downlink subband on an upper portion of a frequency bandwidth part (BWP) and an uplink subband on a lower portion of the BWP. Although not shown in FIG. 11, the uplink subband and downlink subband are typically separated by a guard band (such as guard band 502 shown in FIG. 6). The SSB shown in FIG. 11 may be transmitted by a gNB in a periodic broadcast transmission which may be received by one or more UEs.

UEs operating in SBFD are Half-Duplex, HD. HD UEs can transmit uplink transmissions or receive downlink transmissions but cannot simultaneously transmit an uplink transmission and receive a downlink transmission. Therefore, an HD UE cannot simultaneously receive an SSB and transmit an uplink transmission.

Typically, an HD UE will not receive and measure every SSB in a periodic broadcast. The HD UE may be configured by the gNB to receive and measure a particular SSB in the periodic broadcast or the HD UE may decide which SSB in a periodic broadcast to receive and measure based on UE implementation.

Currently, if a HD UE needs to perform SSB reception and measurement (for example, based on UE implementation) and also needs to transmit an uplink transmission which overlap in time, then the reception and measurement of the SSB is prioritised [6]. In other words, the HD UE may not transmit the uplink transmission and instead receives the SSB. Since the gNB may not know when the HD UE will receive the SSB, (for example, when the UE decides the SSB to receive and measure based on UE implementation), the gNB does not know whether the uplink transmission will be transmitted by the UE. Therefore, the gNB cannot guarantee that an uplink transmission scheduled to the UE would actually be transmitted by the UE, thereby leading to communications resource wastage.

However, another HD UE may transmit an uplink transmission to the gNB which overlaps in time with the SSB. Therefore, as indicated by the arrow in in FIG. 11, the SSB in the SBFD OFDM symbols may suffer from inter subband CLI due to UL transmissions from the other HD UE. In other words, the uplink transmission from the other HD UE interferes with the reception and/or measurement of the SSB of a UE. Since SSB is used for measurements for RACH process, cell selection, synchronisation or general beam selection, inter subband CLI may degrade such measurements and may therefore contribute to an inaccurate estimate of the quality of an SSB beam.

It has been proposed to refrain from transmitting SSBs in SBFD OFDM symbols to avoid the above mentioned inter-subband interference and communications resource wastage [6], [7]. In other words, SSBs are not configured and not located in SBFD OFDM symbols. However, this is expected to be very challenging. This is because SBFD slot format configurations are expected to be configured using a similar method currently used for configuring slot format configurations (such as the method described with reference to FIG. 4 above). In particular, the SBFD Slot Format may be configured with a periodicity following a TDD pattern(s) as defined by that used for cell common Slot Format (as described with reference to FIG. 4 above). Since the SSB and the SBFD configurations are independently configured with separate set of periodicities, it may be challenging to align every SSB occurrence with a non-SBFD slot or non-SBFD OFDM symbols [8].

It has also been proposed to transmit SSBs in SBFD OFDM symbols but to disable the uplink part of those symbols for uplink transmissions [8]. An example is shown in FIG. 12. In FIG. 12, Slot n is an SBFD slot with an SSB in a DL subband between the 4^{th} and 7^{th} OFDM symbol. As shown in FIG. 12, the uplink part of the OFDM symbols used for transmitting the SSB is disabled for uplink transmissions. In other words, the part of the 4^{th}, 5^{th}, 6^{th} and 7^{th} OFDM symbols in the UL subbands are disabled for uplink transmissions. Although this approach reduces the inter-subband interference mentioned above, it may lead to communications resource wastage. For example, for cases where many SSBs are transmitted on many different SSB beams (for example, a periodicity transmission of 8 SSB beams with a periodicity of 5 ms), a significant portion of the uplink subband would become disabled for uplink transmissions, thereby leading to significant communications resource wastage in SBFD slots.

Furthermore, this approach may also increase communications overhead. For example, uplink transmissions which overlap with the uplink part of the OFDM symbols used for transmitting the SSB would be interrupted, thereby causing phase discontinuity. For every phase discontinuity, the UE is required to transmit additional uplink DMRS. For example, referring to FIG. 12, if an uplink transmission was scheduled in the UL subband from the 1^{st} OFDM symbol to the 14^{th} OFDM symbol then the uplink transmission would be interrupted during the 4^{th} to 7^{th} OFDM symbol of the slot. Therefore, the uplink transmission is segmented into two portions: one from the 1^{st} to the 3^{rd} OFDM symbol and another from the 8^{th} to the 14^{th} OFDM symbol of the slot. Each of these portions of the uplink transmission would require at least one DMRS, thereby increasing the DMRS overhead.

Typically, SSBs are located in the middle of a slot. Furthermore, there may be a plurality of SSBs in a slot as shown in FIG. 10. Accordingly, using this approach will likely lead to many uplink transmission interruptions and therefore increased overhead.

It has also been proposed to convert the uplink resources of OFDM symbols used for transmitting SSB to downlink resources. However, doing this would not only interrupt uplink transmissions in the UL subband but would also require the UE to perform UL to DL switching and DL to UL switching, both of which require guard periods. This would therefore lead to further communications resource wastage.

Therefore, there is a need for a half-duplex communications device, infrastructure equipment and methods which can reduce inter-subband CLI and reduce communications resource wastage.

### Disabling Uplink Resource Units

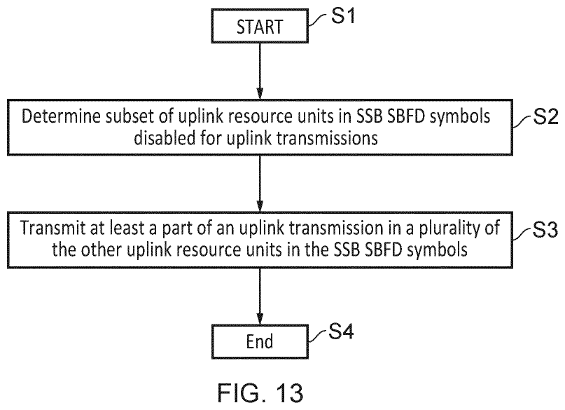

FIG. 13 illustrates a method of operating a half-duplex, HD, communications device in accordance with example embodiments.

The method comprises transmitting an uplink transmission to infrastructure equipment of a wireless communications network via a wireless access interface. The wireless access interface comprises one or more Orthogonal Frequency Division Multiplexing, OFDM, slots. Each the OFDM slots comprises one or more Subband Full Duplex, SBFD, OFDM symbols and each of the one or more SBFD OFDM symbols comprise a plurality of downlink resource units and a plurality of uplink resource units.

One or more of the SBFD OFDM symbols are used by the infrastructure equipment for transmitting a synchronisation signal block, SSB. The SSB is transmitted by the infrastructure equipment in a plurality of the downlink resource units in the one or more SBFD OFDM symbols used for transmitting the SSB.

In some embodiments, the transmission of the SSB by the infrastructure equipment is a broadcast transmission. For example, the infrastructure equipment may transmit the SSB to the communications device and one or more other communications devices. In some embodiments, the transmission of the SSB is periodic.

An SBFD OFDM is an OFDM symbol which comprises a plurality of uplink resource units and a plurality of downlink resource units.

The use of SBFD OFDM symbols for transmitting an SSB may mean that an entire SSB is transmitted in the SBFD OFDM symbols or may mean that the SSB is transmitted partly in the SBFD OFDM symbols. For example, the other part of the SSB may be transmitted in non-SBFD OFDM symbols comprising a plurality of downlink resource units in the OFDM slots.

In some embodiments, the HD communications device may be a HD UE.

In some embodiments, the infrastructure equipment of the wireless communications network may be a gNB.

The resource units may be any unit of frequency resources such as resource elements or resource blocks.

The uplink resource units in an SBFD OFDM slot may be collectively referred to as an uplink subband and the downlink resource units in an SBFD OFDM slot may be collectively referred to as a downlink subband.

The method starts in step S1.

In step S2, the HD communications device determines that a subset of the uplink resource units in the one or more SBFD OFDM symbols used by the infrastructure equipment for transmitting the SSB are disabled for uplink transmissions.

Disabled uplink resource units may not be used by the HD communications device for uplink transmissions while they remain disabled. In some embodiments, the disabled uplink resource units, or a subset of the disabled uplink resource units, may be converted to downlink resource units.

In step S3, the communications device transmits at least a part of the uplink transmission in a plurality of the other uplink resource units in the one or more SBFD OFDM symbols used by the infrastructure equipment for transmitting the SSB.

In step S4, the method ends.

Since only a subset of the uplink resource units in the one or more SBFD OFDM symbols used by the infrastructure equipment for transmitting the SSB are disabled for uplink transmissions, the other uplink resource units in the one or more SBFD OFDM symbols used by the infrastructure equipment for transmitting the SSB are available for uplink transmission. Uplink transmissions can therefore be transmitted in these other uplink resource units without interruption. Therefore, the disabling of the subset of uplink resource units reduces inter-subband CLI whereas the availability of the other uplink resource units for uplink transmissions reduces communications resource wastage.

For conciseness, further references to SBFD OFDM symbols in which an SSB is transmitted or received may be hereafter referred to as “SSB SBFD symbols”. Furthermore, references to communications devices or UEs should be understood as references to HD communications devices and HD UEs respectively.

In some embodiments, the disabled uplink resource units are closer to a guard band separating the uplink and downlink resource units in the SSB SBFD symbols than the other uplink resource units in the SSB SBFD symbols. This creates additional frequency separation between the uplink transmission being transmitted by one communications device (such as a UE) and the SSB being received by another communications device (such as another UE), thereby reducing inter subband CLI. The UE transmitting the uplink transmission may be regarded as an “aggressor UE” whereas another UE receiving the SSB may be regarded as a “victim UE”.

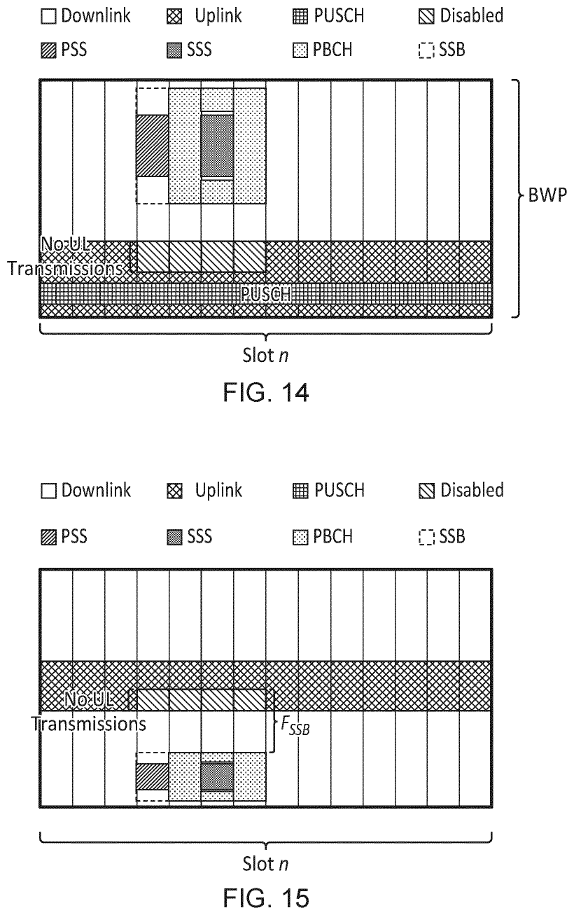

An example is shown in FIG. 14. As shown in FIG. 14, Slot n is an SBFD slot comprising a UL subband and a DL subband. An SSB is shown occupying the DL subband from the 4^{th} to the 7^{th} SBFD OFDM symbol. In this example, a plurality of the uplink resource units in the 4^{th} to the 7^{th} SBFD OFDM symbol are disabled for uplink transmission. Therefore, the other uplink resource units in the 4^{th} to the 7^{th} SBFD OFDM symbol are available for uplink transmission. In this example, a gNB schedules a PUSCH transmission (which is an example of an uplink transmission) in a plurality of the other uplink resource units. The PUSCH is scheduled in across the 1^{st} to 14^{th} SBFD OFDM symbols of Slot n. As shown, a part of the PUSCH transmission is scheduled in uplink resource units which are further away in frequency from a guard band separating the downlink and uplink resource units in the 4^{th} to the 7^{th} SBFD OFDM symbols than the disabled uplink resource units. Therefore, the PUSCH is scheduled without interruptions.

In some embodiments, the disabled uplink resource units are RRC signaled, dynamically indicated using GC-DCI/DCI or pre-defined in the specifications.

In some embodiments, the disabled uplink resource units are uplink resource units in the SSB SBFD symbols which are within a predefined frequency separation of the downlink resource units in the SSB SBFD symbols used for transmitting the SSB. An example as shown in FIG. 15. In FIG. 15, Slot n is an SBFD slot comprising two DL subbands and a UL subband. In this example, the UL subband is between the two DL subbands. Although not shown in FIG. 15, there will typically be a guard band between the UL subband and each of the two DL subbands. A predefined frequency separation, FssB, from the downlink resource units used for receiving the SSB is shown in FIG. 15. As shown, the SSB is transmitted in the 4^{th} to 7^{th} SBFD OFDM symbol in a lower one of the two DL subbands. In FIG. 15, the frequency separation is indicated as starting from the uppermost downlink resource units used for transmitting the SSB, although it will be appreciated that the frequency separation can be defined as starting from any of the downlink resource units used for transmitting the SSB. As shown, the uplink resource units in the SSB in the 4^{th} to 7^{th} SBFD OFDM symbol which are within the predefined frequency separation, FssB, from the downlink resource units used for receiving the SSB, are disabled for uplink transmission.

In some embodiments, the disabled uplink resource units are configured to be indicated by infrastructure equipment of a wireless communications network (such as a gNB) as enabled for uplink transmissions or disabled for uplink transmissions. In other words, the disabled uplink resource are “Flexible” uplink resource units which can be dynamically indicated as enabled or disabled for uplink transmissions. Once enabled, the uplink resource units can be used for uplink transmission.

In some embodiments, the infrastructure equipment may indicate that the flexible uplink resource units are enabled or disabled for uplink transmission explicitly via a DCI such as GC-DCI or implicitly by an UL grant. A GC-DCI may be used to indicate that uplink resource units are enabled or disabled for uplink transmissions for a plurality of UEs in a group. The use of flexible uplink resource units enables the infrastructure equipment the flexibility to control when the uplink resource units should be disabled or enabled. For example, a gNB may determine that the UE transmitting the uplink transmission is far away from a UE receiving the SSB, or that the transmission power of the UE transmitting the uplink transmission is low, and therefore that the uplink transmission will not cause significant inter subband CLI. In this case, the gNB may transmit an indication to the UE transmitting the uplink transmission enable the disabled uplink resource units for uplink transmission. On the other hand, if the gNB determines that the UE transmitting the uplink transmission is close to the UE receiving the SSB, or that the transmission power of the UE transmitting the uplink transmission high, the gNB may determine that the uplink transmission will cause significant inter subband CLI. In this case, the gNB may transmit an indication to disable the uplink resource units to the UE transmitting the uplink transmission.

In some embodiments, all of the uplink resource units in the SSB SBFD symbols are configured to be enabled or disabled for uplink transmissions. In other words, all of the uplink resource units in the SSB SBFD symbols are “Flexible” uplink resource units which can be dynamically indicated as enabled or disabled for uplink transmissions. In some embodiments, all of the uplink resource units in the SSB SBFD symbols may be enabled for uplink transmissions in which case the uplink transmission can be transmitted in any of these uplink resource units. In other embodiments, all of the uplink resource units in the SSB SBFD symbols may be disabled for uplink transmission in which case none of these uplink resource units can be used for uplink transmissions.

In some embodiments, when uplink resource units are enabled or disabled for uplink transmissions, those uplink resource units remain as enabled or disabled for uplink transmissions until the infrastructure equipment indicates otherwise. For example, if a gNB transmits a GC-DCI or UL grant to a UE to indicate that uplink resource units are enabled for uplink transmission, then those uplink resource units will remain enabled for uplink transmissions for the UE until that UE receives another GC-DCI or UL grant which indicates that the uplink resource units are disabled for uplink transmissions.

In some embodiments, when uplink resource units in SSB SBFD symbols are enabled or disabled for uplink transmissions, then corresponding uplink resource units in subsequent SSB SBFD symbols are also enabled or disabled for uplink transmissions respectively until a predetermined time period expires. For example, if disabled uplink resource units are converted to enabled uplink resource units in a set of SSB SDFD symbols comprising an SSB, then corresponding uplink resource units in subsequent sets of SSB SBFD symbols comprising subsequent SSBs also are enabled for uplink transmissions if those uplink resource units fall within the predetermined time period. On the other hand, corresponding uplink resource units in subsequent sets of SSB SBFD symbols comprising subsequent SSBs are disabled for uplink transmissions if those uplink resource units fall after the predetermined time period. It will be appreciated that “corresponding uplink resource units” means uplink resource units with the same position in frequency. In some embodiments, the predetermined time period may be zero. For example, if disabled uplink resource units are converted to enabled uplink resource units in a set of SSB SDFD symbols comprising an SSB, then corresponding uplink resource units in subsequent SSB SBFD symbols comprising subsequent SSBs are disabled for uplink transmissions.

In some embodiments, the predetermined time period can be signaled by RRC, indicated in DCI or predefined in the specifications. In a particular example, infrastructure equipment may transmit an indication to a communications device that a subset of disabled uplink resource units in a set of SSB SBFD symbols comprising an SSB in slot n should be enabled for uplink transmission with a predetermined time period of 0. Therefore, the indicated subset of disabled uplink resource units are enabled for uplink transmission. However, a corresponding subset of uplink resource units in subsequent SSB SBFD symbols comprising subsequent SSBs (for example, a subset of uplink resource units in SSB SBFD symbols comprising an SSB in slot n+10) are disabled for uplink transmissions.

In some embodiments, the uplink resource units which are disabled for uplink transmissions can be used for downlink transmissions. In some embodiments, a subset of the disabled uplink resource units can be used for downlink transmissions whereas the other disabled uplink resource units can be used as part of a guard band between the uplink resource units and downlink resource units in the SSB SBFD symbols. For example, if there are 10 disabled uplink resource units in a UL subband, 6 of those uplink resource units may be used as downlink resource units and 4 of those uplink resource units may be used as part of the guard band.

### Types of UL Transmissions

In accordance with example embodiments, another a method of operating a half-duplex, HD, communications device is provided.

The method comprises transmitting an uplink transmission to infrastructure equipment of a wireless communications network via a wireless access interface. The wireless access interface comprises one or more OFDM, slots. One or more of the OFDM slots comprises a plurality SBFD OFDM symbols. Each of the one or more SBFD OFDM symbols comprises a plurality of downlink resource units and a plurality of uplink resource units.

One or more of the SBFD OFDM symbols are used by the infrastructure equipment for transmitting an SSB. The SSB is transmitted by the infrastructure equipment in a plurality of the downlink resource units in the one or more SBFD OFDM symbols used for transmitting the SSB.

The transmitting of the uplink transmission comprises determining, based on a type of the uplink transmission, to transmit at least a part of the uplink transmission in a plurality of the uplink resource units in the one or more SBFD OFDM symbols used by the infrastructure equipment for transmitting the SSB.

By determining whether to transmit at least a part of the uplink transmission in a plurality of the uplink resource units in the one or more SBFD OFDM symbols used by the infrastructure equipment for transmitting the SSB based on the type of the uplink transmission, the uplink transmission can be prioritised over the SSB when required. For example, although the transmission of the uplink transmission may cause inter-subband CLI to other communications devices which may be receiving the SSB, such embodiments recognise that it may be acceptable to have such interference due to the importance of the uplink transmission. In another example, the communications device may determine to transmit the uplink transmission even though an implementation of the communications device indicates that it should receive the SSB. In other words, the communications device prioritises the transmission of the uplink transmission over its own reception of the SSB based on the type of the uplink transmission.

As explained in more detail below, types of an uplink transmission include uplink transmissions that are transmitted in a CG-PUSCH, high L1 priority uplink transmissions, uplink transmissions that comprise a HARQ-ACK or HARQ-NACK, and uplink transmissions which comprise at least two HARQ-ACKs or HARQ-ACKs.

In some embodiments, the communications device will transmit the uplink transmission in uplink resource units of the SSB SBFD symbols if the uplink transmission is transmitted in a Configured Grant PUSCH (CG-PUSCH). As will be appreciated, gNBs typically blind decodes CG-PUSCH regardless of whether or not an uplink transmission is actually transmitted in the CG-PUSCH. This is because resources for CG-PUSCH are semi-statically configured and may or may not be used by a UE. In other words, the use of CG-PUSCH introduces uncertainty at the gNB. However, since the gNB does not know whether a UE will transmit an uplink transmission in SSB SBFD symbols or receive the SSB, the gNB will have to blind decode for a dynamically scheduled uplink transmission, which is similar behaviour as blind decoding for a CG-PUSCH. Such embodiments of allowing CG-PUSCH to transmit in SSB SFBD symbols would therefore not increase the gNB's effort in performing blind decodes.

In some embodiments, the communications device receives an indication from the infrastructure equipment that the uplink transmission has a high L1 priority. As will be appreciated, high L1 priority transmissions are typically used for URLLC packets, which have very stringent latency requirements, and which therefore should be transmitted as soon as possible. In some embodiments, the communications device determines to transmit the uplink transmission in uplink resource units of the SSB SBFD symbols. PUSCH or PUCCH transmissions may have a high L1 priority, for example.

In some embodiments, the communications device will transmit the uplink transmission in uplink resource units of the SSB SBFD symbols if the uplink transmission comprises a Hybrid Automatic Repeat Request, HARQ, acknowledgement, ACK or negative acknowledgment, NACK. An uplink transmission which comprises a HARQ-ACK or HARQ-NACK may be transmitted in PUCCH or PUSCH, for example. The infrastructure equipment may be configured to know whether the communications device will transmit a HARQ-ACK for HARQ-NACK in uplink resource units of the SSB SBFD symbols so that the infrastructure equipment can react appropriately. For example, if the infrastructure equipment is aware that the communications device will not transmit HARQ-ACKs in the uplink resource units of the SSB SBFD symbols, then the infrastructure equipment may assume that the absence of an expected uplink transmission comprising HARQ-ACK means the communications device has successfully decoded the corresponding PDSCH. On the other hand, if the infrastructure equipment is aware that the communications device will not transmit HARQ-NACKs in the uplink resource units of the SSB SBFD symbols, then the infrastructure equipment may assume that an absence of an uplink transmission comprising a HARQ-ACK means the UE failed to decode the corresponding PDSCH. Therefore, the infrastructure equipment may schedule a retransmission for that PDSCH.

In some embodiments, the communications device will transmit the uplink transmission in uplink resource units of the SSB SBFD symbols if the uplink transmission comprises at least two HARQ feedbacks. For example, the communications device will transmit the uplink transmission in uplink resource units of the SSB SBFD symbols if the uplink transmission comprises at least two HARQ-ACKs, at least two HARQ-NACKs or at least one HARQ-ACK and at least one HARQ-NACK. Such embodiments are particularly advantageous because missing an uplink transmission carrying multiple HARQ-ACKs or NACKs (such as a PUCCH/PUSCH) will affect multiple PDSCHs. Therefore, the gNB would typically retransmit all of the PDSCHs, thereby wasting DL resources.

### Combined Restrictions on Uplink Resource Units and Type of Uplink Transmission

As mentioned above, embodiments are provided in which a communications device determines that a subset of the uplink resource units in SSB SBFD symbols are disabled for uplink transmissions, and transmits at least a part of the uplink transmission in a plurality of the other uplink resource units in the SSB SBFD symbols.

In some embodiments, the decision of whether to transmit at least the part of the uplink transmission in the plurality of the other uplink resource units in the SSB SBFD symbols (i.e. the uplink resource units other than the disabled subset of uplink resource units) is based on a type of the uplink transmission.

As explained above, types an uplink transmission include uplink transmissions that are transmitted in a CG-PUSCH, high L1 priority uplink transmissions, uplink transmissions that comprise a HARQ-ACK or HARQ-NACK, and uplink transmissions which comprise at least two HARQ-ACKs or HARQ-ACKs.

Such embodiments can achieve both reduced inter-subband CLI and increased certainty at the infrastructure equipment.

The following numbered paragraphs provide further example aspects and features of the present technique:

Paragraph 1. A method of operating a half-duplex, HD, communications device, the method comprising
transmitting an uplink transmission to infrastructure equipment of a wireless communications network via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units, wherein
one or more of the SBFD OFDM symbols are used by the infrastructure equipment for transmitting a synchronisation signal block, SSB, the SSB being transmitted by the infrastructure equipment in a plurality of the downlink resource units in the one or more SBFD OFDM symbols used for transmitting the SSB and
the transmitting of the uplink transmission comprises
determining that a subset of the uplink resource units in the one or more SBFD OFDM symbols used by the infrastructure equipment for transmitting the SSB are disabled for uplink transmissions, and
transmitting at least a part of the uplink transmission in a plurality of the other uplink resource units in the one or more SBFD OFDM symbols used by the infrastructure equipment for transmitting the SSB.

Paragraph 2. A method according to paragraph 1, wherein the determining that a subset of the uplink resource units in the one or more SBFD OFDM symbols used by the infrastructure equipment for transmitting the SSB are disabled for uplink transmissions comprises
receiving, from the infrastructure equipment, an indication of the disabled subset of uplink resource units.

Paragraph 3. A method according to paragraph 2, wherein the disabled uplink resource units are configured to be indicated by the infrastructure equipment as enabled for uplink transmissions or disabled for uplink transmissions, wherein
the indication of the disabled subset of the uplink resource units received from the infrastructure equipment comprises an indication to disable the subset of the uplink resource units.

Paragraph 4. A method according to paragraph 3, wherein the indication to disable the subset of the uplink resource units comprises
an indication to disable a corresponding plurality of uplink resource units in subsequent SBFD OFDM symbols used by the infrastructure equipment for transmitting subsequent SSBs until expiry of a predetermined time period from the end of the subset of uplink resource units.

Paragraph 5. A method according to paragraph 4, wherein the indication to disable the subset of the uplink resource units comprises
receiving, from the infrastructure equipment, an indication of the predetermined time period.

Paragraph 6. A method according to paragraph 4, comprising
determining the pre-determined time period based on pre-defined specifications for the HD communications device.

Paragraph 7. A method according to any of paragraphs 2 to 6, wherein the indication of the disabled subset of the uplink resource units is comprised in downlink control information, DCI, or Group Common, GC, DCI.

Paragraph 8. A method according to any of paragraphs 1 to 7, wherein the other uplink resource units in the one or more SBFD OFDM symbols used by the other HD communications device for receiving the SSB are configured to be indicated by the infrastructure equipment as enabled for uplink transmissions or disabled for uplink transmissions, and the transmitting at least a part of the uplink transmission in a plurality of the other uplink resource units in the one or more SBFD OFDM symbols used by the infrastructure equipment for transmitting the SSB comprises
receiving, from the infrastructure equipment, an indication to enable the other uplink resource units for uplink transmissions.

Paragraph 9. A method according to paragraph 8, wherein the indication to enable the other uplink resource units for uplink transmissions is comprised in downlink control information, DCI, or Group Common, GC, DCI, or an uplink grant.

Paragraph 10. A method according to paragraph 1, wherein the determining that a subset of the uplink resource units in the one or more SBFD OFDM symbols used by the infrastructure equipment for transmitting the SSB are disabled for uplink transmissions comprises
determining the disabled subset of uplink resource units based on pre-defined specifications for the HD communications device.

Paragraph 11. A method according to any of paragraphs 1 to 10, wherein the disabled uplink resource units are uplink resource units in the one or more SBFD OFDM symbols used by the infrastructure equipment for transmitting the SSB which are within a pre-defined frequency separation of the downlink resource units used for transmitting the SSB.

Paragraph 12. A method according to any of paragraphs 1 to 11, wherein the transmitting at least a part of the uplink transmission in a plurality of the other uplink resource units in the one or more SBFD OFDM symbols used by the infrastructure equipment for transmitting the SSB comprises
determining, based on a type of the uplink transmission, to transmit at least the part of the uplink transmission in the plurality of the other uplink resource units.

Paragraph 13. A method according to paragraph 12, wherein the determining, based on a type of the uplink transmission, to transmit at least the part of the uplink transmission in the plurality of the other uplink resource units comprises
determining that the uplink transmission is to be transmitted in a configured grant, CG, Physical Uplink Shared Channel.

Paragraph 14. A method according to paragraph 12, wherein the determining, based on a type of the uplink transmission, to transmit at least the part of the uplink transmission in the plurality of the other uplink resource units comprises receiving, from the infrastructure equipment, an indication that the uplink transmission has a high L1 priority.

Paragraph 15. A method according to paragraph 12, wherein the determining, based on a type of the uplink transmission, to transmit at least the part of the uplink transmission in the plurality of the other uplink resource units comprises
determining that the uplink transmission comprises a Hybrid Automatic Repeat Request, HARQ, acknowledgement, ACK or negative acknowledgment, NACK.

Paragraph 16. A method according to paragraph 15, wherein the determining that the uplink transmission comprises a HARQ-ACK or HARQ-NACK comprises
determining that the uplink transmission comprises at least two HARQ-ACKs, at least two HARQ-NACKs or at least one HARQ-ACK and at least one HARQ-NACK.

Paragraph 17. A method according to any of paragraphs 1 to 16, comprising
converting a subset of the disabled uplink resource units to downlink resource units.

Paragraph 18. A method according to paragraph 17, comprising
converting all of the disabled uplink resource units to downlink resource units.

Paragraph 19. A method according to any of paragraphs 1 to 18, wherein the disabled uplink resource units are closer in frequency to the downlink resource units in the one or more SBFD OFDM symbols used by the infrastructure equipment for transmitting the SSB than the other uplink resource units in the one or more SBFD OFDM symbols used by the infrastructure equipment for transmitting the SSB.

Paragraph 20. A method according to any of paragraphs 1 to 19, wherein one or more of the OFDM slots comprise a plurality of non-SBFD OFDM symbols, each of the non-SBFD OFDM symbols comprising a plurality of downlink resource units, wherein a part of the SSB is transmitted in a plurality of the downlink resource units in the non-SBFD OFDM symbols.

Paragraph 21. A method of operating a half-duplex, HD, communications device, the method comprising
transmitting an uplink transmission to infrastructure equipment of a wireless communications network via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units, wherein
one or more of the SBFD OFDM symbols are used by the infrastructure equipment for transmitting a synchronisation signal block, SSB, the SSB being transmitted by the infrastructure equipment in a plurality of the downlink resource units in the one or more SBFD OFDM symbols used for transmitting the SSB, and the transmitting of the uplink transmission comprises
determining, based on a type of the uplink transmission, to transmit at least a part of the uplink transmission in a plurality of the uplink resource units in the one or more SBFD OFDM symbols used by the infrastructure equipment for transmitting the SSB.

Paragraph 22. A method according to paragraph 21, wherein the determining, based on a type of the uplink transmission, to transmit at least the part of the uplink transmission in the plurality of the uplink resource units comprises
determining that the uplink transmission is to be transmitted in a configured grant, CG, Physical Uplink Shared Channel.

Paragraph 23. A method according to paragraph 21, wherein the determining, based on a type of the uplink transmission, to transmit at least the part of the uplink transmission in the plurality of the uplink resource units comprises
receiving, from the infrastructure equipment, an indication that the uplink transmission has a high L1 priority.

Paragraph 24. A method according to paragraph 21, wherein the determining, based on a type of the uplink transmission, to transmit at least the part of the uplink transmission in the plurality of the uplink resource units comprises
determining that the uplink transmission comprises a Hybrid Automatic Repeat Request, HARQ, acknowledgement, ACK or negative acknowledgment, NACK.

Paragraph 25. A method according to paragraph 24, wherein the determining that the uplink transmission comprises a HARQ-ACK or HARQ-NACK comprises
determining that the uplink transmission comprises at least two HARQ-ACKs, at least two HARQ-NACKs or at least one HARQ-ACK and at least one HARQ-NACK.

Paragraph 26. A method of operating infrastructure equipment of a wireless communications network, the method comprising
receiving, from a half-duplex, HD, communications device, an uplink transmission via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units,
transmitting a synchronisation signal block, SSB, in one or more of the SBFD OFDM symbols, the SSB being transmitted in a plurality of the downlink resource units in the one or more SBFD OFDM symbols used for transmitting the SSB, and
receiving at least a part of the uplink transmission in a plurality of the uplink resource units in the one or more SBFD OFDM symbols used for transmitting the SSB other than a subset of the uplink resource units in the one or more SBFD OFDM symbols used for transmitting the SSB which are disabled for uplink transmissions.

Paragraph 27. A method of operating infrastructure equipment of a wireless communications network, the method comprising
receiving, from a half-duplex, HD, communications device, an uplink transmission via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units,
transmitting a synchronisation signal block, SSB, in one or more of the SBFD OFDM symbols, the SSB being transmitted in a plurality of the downlink resource units in the one or more SBFD OFDM symbols used for transmitting the SSB, and
receiving, based on a type of the uplink transmission, at least a part of the uplink transmission in a plurality of the uplink resource units in the one or more SBFD OFDM symbols used for transmitting the SSB.

Paragraph 28. A method according to paragraph 27, wherein the receiving, based on a type of the uplink transmission, at least a part of the uplink transmission in a plurality of the uplink resource units in the one or more SBFD OFDM symbols used for transmitting the SSB comprises
transmitting, to the HD communications device, an indication of one or more types of uplink transmission which may be transmitted in the plurality of the uplink resource units in the one or more SBFD OFDM symbols used for transmitting the SSB.

Paragraph 29. A method according to any of paragraphs 27 to 28, wherein the receiving, based on a type of the uplink transmission, at least a part of the uplink transmission in a plurality of the uplink resource units in the one or more SBFD OFDM symbols used for transmitting the SSB comprises
receiving the uplink transmission in a configured grant, CG, Physical Uplink Shared Channel.

Paragraph 30. A method according to any of paragraphs 27 to 28, wherein the uplink transmission has a high L1 priority.

Paragraph 31. A method according to any of paragraphs 27 to 28, wherein the uplink transmission comprises a Hybrid Automatic Repeat Request, HARQ, acknowledgement, ACK or negative acknowledgment, NACK.

Paragraph 32. A method according to paragraph 31, wherein the uplink transmission comprises at least two HARQ-ACKs, at least two HARQ-NACKs or at least one HARQ-ACK and at least one HARQ-NACK.

Paragraph 33. A half-duplex, HD, communications device comprising
a transmitter configured to transmit signals,
a receiver configured to receive signals, and
a controller configured in combination with the transmitter and the receiver to
transmit an uplink transmission to infrastructure equipment of a wireless communications network via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units, wherein
one or more of the SBFD OFDM symbols are used by the infrastructure equipment for transmitting a synchronisation signal block, SSB, the SSB being transmitted by the infrastructure equipment in a plurality of the downlink resource units in the one or more SBFD OFDM symbols used for transmitting the SSB and
the transmitting of the uplink transmission comprises
determining that a subset of the uplink resource units in the one or more SBFD OFDM symbols used by the infrastructure equipment for transmitting the SSB are disabled for uplink transmissions, and
transmitting at least a part of the uplink transmission in a plurality of the other uplink resource units in the one or more SBFD OFDM symbols used by the infrastructure equipment for transmitting the SSB.

Paragraph 34. A half-duplex, HD, communications device comprising
a transmitter configured to transmit signals,
a receiver configured to receive signals, and
a controller configured in combination with the transmitter and the receiver to
transmit an uplink transmission to infrastructure equipment of a wireless communications network via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units, wherein
one or more of the SBFD OFDM symbols are used by the infrastructure equipment for transmitting a synchronisation signal block, SSB, the SSB being transmitted by the infrastructure equipment in a plurality of the downlink resource units in the one or more SBFD OFDM symbols used for transmitting the SSB, and the transmitting of the uplink transmission comprises
determining, based on a type of the uplink transmission, to transmit at least a part of the uplink transmission in a plurality of the uplink resource units in the one or more SBFD OFDM symbols used by the infrastructure equipment for transmitting the SSB.

Paragraph 35. Infrastructure equipment for a wireless communications network, the infrastructure equipment comprising
a transmitter configured to transmit signals,
a receiver configured to receive signals, and
a controller configured in combination with the transmitter and the receiver to
receive, from a half-duplex, HD, communications device, an uplink transmission via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units,
transmit a synchronisation signal block, SSB, in one or more of the SBFD OFDM symbols, the SSB being transmitted in a plurality of the downlink resource units in the one or more SBFD OFDM symbols used for transmitting the SSB, and
receive at least a part of the uplink transmission in a plurality of the uplink resource units in the one or more SBFD OFDM symbols used for transmitting the SSB other than a subset of the uplink resource units in the one or more SBFD OFDM symbols used for transmitting the SSB which are disabled for uplink transmissions.

Paragraph 36. Infrastructure equipment for a wireless communications network, the infrastructure equipment comprising
a transmitter configured to transmit signals,
a receiver configured to receive signals, and
a controller configured in combination with the transmitter and the receiver to
receive, from a half-duplex, HD, communications device, an uplink transmission via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units,
transmit a synchronisation signal block, SSB, in one or more of the SBFD OFDM symbols, the SSB being transmitted in a plurality of the downlink resource units in the one or more SBFD OFDM symbols used for transmitting the SSB, and
receive, based on a type of the uplink transmission, at least a part of the uplink transmission in a plurality of the uplink resource units in the one or more SBFD OFDM symbols used for transmitting the SSB.

Paragraph 37. Circuitry for a half-duplex, HD, communications device, the circuitry comprising
transmitter circuitry configured to transmit signals,
receiver circuitry configured to receive signals, and
controller circuitry configured in combination with the transmitter circuitry and the receiver circuitry to
transmit an uplink transmission to infrastructure equipment of a wireless communications network via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units, wherein
one or more of the SBFD OFDM symbols are used by the infrastructure equipment for transmitting a synchronisation signal block, SSB, the SSB being transmitted by the infrastructure equipment in a plurality of the downlink resource units in the one or more SBFD OFDM symbols used for transmitting the SSB and
the transmitting of the uplink transmission comprises
determining that a subset of the uplink resource units in the one or more SBFD OFDM symbols used by the infrastructure equipment for transmitting the SSB are disabled for uplink transmissions, and
transmitting at least a part of the uplink transmission in a plurality of the other uplink resource units in the one or more SBFD OFDM symbols used by the infrastructure equipment for transmitting the SSB.

Paragraph 38. Circuitry for a half-duplex, HD, communications device, the circuitry comprising
transmitter circuitry configured to transmit signals,
receiver circuitry configured to receive signals, and
controller circuitry configured in combination with the transmitter circuitry and the receiver circuitry to
transmit an uplink transmission to infrastructure equipment of a wireless communications network via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units, wherein
one or more of the SBFD OFDM symbols are used by the infrastructure equipment for transmitting a synchronisation signal block, SSB, the SSB being transmitted by the infrastructure equipment in a plurality of the downlink resource units in the one or more SBFD OFDM symbols used for transmitting the SSB, and the transmitting of the uplink transmission comprises
determining, based on a type of the uplink transmission, to transmit at least a part of the uplink transmission in a plurality of the uplink resource units in the one or more SBFD OFDM symbols used by the infrastructure equipment for transmitting the SSB.

Paragraph 39. Circuitry for infrastructure equipment for a wireless communications network, the circuitry comprising
transmitter circuitry configured to transmit signals,
receiver circuitry configured to receive signals, and
controller circuitry configured in combination with the transmitter circuitry and the receiver circuitry to
receive, from a half-duplex, HD, communications device, an uplink transmission via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units,
transmit a synchronisation signal block, SSB, in one or more of the SBFD OFDM symbols, the SSB being transmitted in a plurality of the downlink resource units in the one or more SBFD OFDM symbols used for transmitting the SSB, and
receive at least a part of the uplink transmission in a plurality of the uplink resource units in the one or more SBFD OFDM symbols used for transmitting the SSB other than a subset of the uplink resource units in the one or more SBFD OFDM symbols used for transmitting the SSB which are disabled for uplink transmissions.

Paragraph 40. Circuitry for infrastructure equipment for a wireless communications network, the circuitry comprising
transmitter circuitry configured to transmit signals,
receiver circuitry configured to receive signals, and
controller circuitry configured in combination with the transmitter circuitry and the receiver circuitry to
receive, from a half-duplex, HD, communications device, an uplink transmission via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units,
transmit a synchronisation signal block, SSB, in one or more of the SBFD OFDM symbols, the SSB being transmitted in a plurality of the downlink resource units in the one or more SBFD OFDM symbols used for transmitting the SSB, and
receive, based on a type of the uplink transmission, at least a part of the uplink transmission in a plurality of the uplink resource units in the one or more SBFD OFDM symbols used for transmitting the SSB.

Paragraph 41. A wireless communications network comprising a communications device according to paragraph 33 and infrastructure equipment according to paragraph 35.

Paragraph 42. A wireless communications network comprising a communications device according to paragraph 34 and infrastructure equipment according to paragraph 36.

Paragraph 43. A computer program comprising instructions which, when program is executed by a computer, cause the computer perform the method of any of paragraphs 1 to 32.

Paragraph 44. A non-transitory computer-readable storage medium storing a computer program according to paragraph 43.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

It will be appreciated by one skilled in the art that references to pre-defining information for a communications device in the specifications (such as 3GPP specifications) means that this information is preconfigured, or “hard-wired”, in the communications device.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, 3rd Generation Partnership Project, v14.3.0, August 2017.
[3] RP-213591, “New SI: Study on evolution of NR duplex operation,” CMCC, RAN #94e, December 2021.
[4] RP-220633, “Revised SID: Study on evolution of NR duplex operation,” CMCC, RAN #95e, March 2022.
[5] European Patent No. 3545716.
[6] R1-2302599, “Discussion on subband non-overlapping full duplex,” Spreadtrum Communications, RAN1 #112bis-e
[7] R1-2302702, “Discussion on subband non-overlapping full duplex,” CATT, RAN1 #112bis-e.
[8] R1-2304031, “Summary #4 of subband non-overlapping full duplex,” Moderator (CATT), RAN1 #112bis-e.

1. A method of operating a half-duplex, HD, communications device, the method comprising
transmitting an uplink transmission to infrastructure equipment of a wireless communications network via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units, wherein
one or more of the SBFD OFDM symbols are used by the infrastructure equipment for transmitting a synchronisation signal block, SSB, the SSB being transmitted by the infrastructure equipment in a plurality of the downlink resource units in the one or more SBFD OFDM symbols used for transmitting the SSB and
the transmitting of the uplink transmission comprises
determining that a subset of the uplink resource units in the one or more SBFD OFDM symbols used by the infrastructure equipment for transmitting the SSB are disabled for uplink transmissions, and
transmitting at least a part of the uplink transmission in a plurality of the other uplink resource units in the one or more SBFD OFDM symbols used by the infrastructure equipment for transmitting the SSB.

2. A method according to claim 1, wherein the determining that a subset of the uplink resource units in the one or more SBFD OFDM symbols used by the infrastructure equipment for transmitting the SSB are disabled for uplink transmissions comprises
receiving, from the infrastructure equipment, an indication of the disabled subset of uplink resource units.

3. A method according to claim 2, wherein the disabled uplink resource units are configured to be indicated by the infrastructure equipment as enabled for uplink transmissions or disabled for uplink transmissions, wherein
the indication of the disabled subset of the uplink resource units received from the infrastructure equipment comprises an indication to disable the subset of the uplink resource units.

4. A method according to claim 3, wherein the indication to disable the subset of the uplink resource units comprises
an indication to disable a corresponding plurality of uplink resource units in subsequent SBFD OFDM symbols used by the infrastructure equipment for transmitting subsequent SSBs until expiry of a predetermined time period from the end of the subset of uplink resource units.

5. A method according to claim 4, wherein the indication to disable the subset of the uplink resource units comprises
receiving, from the infrastructure equipment, an indication of the predetermined time period.

6. A method according to claim 4, comprising
determining the pre-determined time period based on pre-defined specifications for the HD communications device.

7. A method according to claim 2, wherein the indication of the disabled subset of the uplink resource units is comprised in downlink control information, DCI, or Group Common, GC, DCI.

8. A method according to claim 1, wherein the other uplink resource units in the one or more SBFD OFDM symbols used by the other HD communications device for receiving the SSB are configured to be indicated by the infrastructure equipment as enabled for uplink transmissions or disabled for uplink transmissions, and the transmitting at least a part of the uplink transmission in a plurality of the other uplink resource units in the one or more SBFD OFDM symbols used by the infrastructure equipment for transmitting the SSB comprises
receiving, from the infrastructure equipment, an indication to enable the other uplink resource units for uplink transmissions.

9. A method according to claim 8, wherein the indication to enable the other uplink resource units for uplink transmissions is comprised in downlink control information, DCI, or Group Common, GC, DCI, or an uplink grant.

10. A method according to claim 1, wherein the determining that a subset of the uplink resource units in the one or more SBFD OFDM symbols used by the infrastructure equipment for transmitting the SSB are disabled for uplink transmissions comprises
determining the disabled subset of uplink resource units based on pre-defined specifications for the HD communications device.

11. A method according to claim 1, wherein the disabled uplink resource units are uplink resource units in the one or more SBFD OFDM symbols used by the infrastructure equipment for transmitting the SSB which are within a pre-defined frequency separation of the downlink resource units used for transmitting the SSB.

12. A method according to claim 1, wherein the transmitting at least a part of the uplink transmission in a plurality of the other uplink resource units in the one or more SBFD OFDM symbols used by the infrastructure equipment for transmitting the SSB comprises
determining, based on a type of the uplink transmission, to transmit at least the part of the uplink transmission in the plurality of the other uplink resource units.

13. A method according to claim 12, wherein the determining, based on a type of the uplink transmission, to transmit at least the part of the uplink transmission in the plurality of the other uplink resource units comprises
determining that the uplink transmission is to be transmitted in a configured grant, CG, Physical Uplink Shared Channel.

14. A method according to claim 12, wherein the determining, based on a type of the uplink transmission, to transmit at least the part of the uplink transmission in the plurality of the other uplink resource units comprises
receiving, from the infrastructure equipment, an indication that the uplink transmission has a high L1 priority.

15. A method according to claim 12, wherein the determining, based on a type of the uplink transmission, to transmit at least the part of the uplink transmission in the plurality of the other uplink resource units comprises
determining that the uplink transmission comprises a Hybrid Automatic Repeat Request, HARQ, acknowledgement, ACK or negative acknowledgment, NACK.

16. A method according to claim 15, wherein the determining that the uplink transmission comprises a HARQ-ACK or HARQ-NACK comprises
determining that the uplink transmission comprises at least two HARQ-ACKs, at least two HARQ-NACKs or at least one HARQ-ACK and at least one HARQ-NACK.

17. A method according to claim 1, comprising converting a subset of the disabled uplink resource units to downlink resource units.

18. (canceled)

19. A method according to claim 1, wherein the disabled uplink resource units are closer in frequency to the downlink resource units in the one or more SBFD OFDM symbols used by the infrastructure equipment for transmitting the SSB than the other uplink resource units in the one or more SBFD OFDM symbols used by the infrastructure equipment for transmitting the SSB.

20.-32. (canceled)

33. A half-duplex, HD, communications device comprising
a transmitter configured to transmit signals,
a receiver configured to receive signals, and
a controller configured in combination with the transmitter and the receiver to
transmit an uplink transmission to infrastructure equipment of a wireless communications network via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units, wherein
one or more of the SBFD OFDM symbols are used by the infrastructure equipment for transmitting a synchronisation signal block, SSB, the SSB being transmitted by the infrastructure equipment in a plurality of the downlink resource units in the one or more SBFD OFDM symbols used for transmitting the SSB and
the transmitting of the uplink transmission comprises
determining that a subset of the uplink resource units in the one or more SBFD OFDM symbols used by the infrastructure equipment for transmitting the SSB are disabled for uplink transmissions, and
transmitting at least a part of the uplink transmission in a plurality of the other uplink resource units in the one or more SBFD OFDM symbols used by the infrastructure equipment for transmitting the SSB.

34. (canceled)

35. Infrastructure equipment for a wireless communications network, the infrastructure equipment comprising
a transmitter configured to transmit signals,
a receiver configured to receive signals, and
a controller configured in combination with the transmitter and the receiver to
receive, from a half-duplex, HD, communications device, an uplink transmission via a wireless access interface, the wireless access interface comprising one or more Orthogonal Frequency Division Multiplexing, OFDM, slots, one or more of the OFDM slots comprising one or more Subband Full Duplex, SBFD, OFDM symbols, each of the one or more SBFD OFDM symbols comprising a plurality of downlink resource units and a plurality of uplink resource units,
transmit a synchronisation signal block, SSB, in one or more of the SBFD OFDM symbols, the SSB being transmitted in a plurality of the downlink resource units in the one or more SBFD OFDM symbols used for transmitting the SSB, and
receive at least a part of the uplink transmission in a plurality of the uplink resource units in the one or more SBFD OFDM symbols used for transmitting the SSB other than a subset of the uplink resource units in the one or more SBFD OFDM symbols used for transmitting the SSB which are disabled for uplink transmissions.

36.-44. (canceled)
